(19) United States
(12) Patent Application Publication
(10) Pub. No.: US 2015/0369471 A1
(43) Pub. Date: Dec. 24, 2015

(54) WASTE DISPOSAL WITH ASSOCIATED LIGHTING

(71) Applicant: General Electric Company, Schenectady, NY (US)

(72) Inventor: Daryl C. Williams, Louisville, KY (US)

(21) Appl. No.: 14/311,520

(22) Filed: Jun. 23, 2014

(51) Int. Cl. F21V 33/00; F21V 23/00; F21V 23/04; E03C 1/266

(52) U.S. Cl. CPC F21V 33/0012; E03C 1/2665; F21V 33/0044; F21V 23/003; F21V 23/0471; F21W 2131/301

(57) ABSTRACT

In one aspect, a system for lighting an under-sink storage space defined beneath a sink may generally include a waste disposal positioned within the under-sink storage space that is in fluid communication with the sink. The waste disposal may include a motor and a cutter system for processing water and waste discharged from the sink. In addition, the system may include a light source associated with the waste disposal that is configured to illuminate at least a portion of the under-sink storage space. Moreover, the system may be configured such that the light source and the motor are electrically connected to a common electrical circuit.

### FIELD OF THE INVENTION

The present subject matter relates generally to under-sink storage space and, more particularly, to a waste disposal including an associated light source for improved under-sink storage space utilization.

### BACKGROUND OF THE INVENTION

A kitchen sink is typically supported by a countertop positioned atop under-sink cabinetry. Additionally, an under-sink storage space is typically defined directly below the sink that is accessible via cabinet doors of the associated cabinetry. Given its limited capacity and poor lighting conditions, such under-sink storage space currently corresponds to one of most underutilized storage areas within a residential kitchen.

To address the poor lighting conditions, various supplemental lighting solutions have been proposed for illuminating the under-sink storage space. Specifically, conventional lighting solutions typically correspond to a battery-powered, manual switch-activated light that is configured to be mounted to a portion of the under-sink cabinetry. Unfortunately, such lighting systems do not provide an optimal solution for the poor lighting conditions found within the under-sink storage space. For example, current systems typically require that the light be mounted to the floor or wall of the interior of the cabinetry or to one of the cabinet doors. However, floor mounting reduces the usable area within the storage space while wall mounting typically places the light in a difficult location to reach (e.g., at the back of the storage space). Similarly, door mounting of the light places the light quite far away from the area needing illumination. Moreover, the use of batteries typically limits the intensity of the light available to be used and requires periodic maintenance by the consumer (e.g., to replace the batteries).

Accordingly, an improved system for lighting an under-sink storage space would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for lighting an under-sink storage space defined beneath a sink. The system may generally include a waste disposal positioned within the under-sink storage space that is in fluid communication with the sink. The waste disposal may include a motor and a cutter system for processing water and waste discharged from the sink. In addition, the system may include a light source associated with the waste disposal that is configured to illuminate at least a portion of the under-sink storage space. Moreover, the system may be configured such that the light source and the motor are electrically connected to a common electrical circuit.

In another aspect, the present subject matter is directed to a system for lighting an under-sink storage space defined beneath a sink. The system may generally include a waste disposal positioned within the under-sink storage space that is in fluid communication with the sink. The waste disposal may include a motor and a cutter system for processing water and waste discharged from the sink. The system may also include a light source associated with the waste disposal that is configured to illuminate at least a portion of the under-sink storage space. In addition, the system may include a motion sensor configured to activate the light source when movement is detected within or adjacent to the under-sink storage space.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a kitchen sink and associated under-sink cabinetry, particularly illustrating a system for lighting the under-sink storage space installed within the cabinetry in accordance with aspects of the present subject matter;

FIG. 2 illustrates a side view of the system shown in FIG. 1; and

FIG. 3 illustrates one embodiment of a simplified, schematic electrical diagram that can be used with the system shown in FIGS. 1 and 2 in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system for lighting an under-sink storage space defined within associated cabinetry positioned beneath a kitchen sink or any other suitable sink. In several embodiments, the system may include a waste disposal installed within the under-sink storage space and one or more light sources integrated within or otherwise associated with the disposal. Specifically, the light source(s) may be positioned on the outside of the disposal housing such that the light generated by the light source(s) illuminates the under-sink storage space. Such illumination may provide a consumer improved visibility within the under-sink storage space, thereby increasing the usability of the space.

Additionally, in several embodiments, the system may include a motion sensor for activating or otherwise turning on the light source(s). For instance, the motion sensor may be configured to detect motion occurring within and/or adjacent to the under-sink storage space, such as the opening of an associated cabinet door and/or the consumer moving his/her hand within the storage space. Upon the detection of motion, the light source(s) may be activated so as to illuminate the under-sink storage space. Such a motion-activated light source(s) allows for the under-sink storage space to be illuminated without the need for the consumer to find and manipulate an associated switching mechanism, thereby reducing the complexity of the system. Moreover, in a particular embodiment, the light source may only be configured to be activated for a predetermined time period (e.g., 30 seconds) after the last motion is detected by the motion sensor. Thereafter, the light source may be automatically turned off, thereby preventing instances in which the consumer inadvertently leaves the light on after using the storage space.

Further, in several embodiments, the motor of the waste disposal, the light source(s) and the motion sensor may all be electrically connected to a common electrical circuit, thereby allowing each component to be powered via the same power source. For instance, in one embodiment, such components may be electrically connected to an internal electrical circuit of the disposal, which may, in turn, be electrically connected (e.g., via a circuit breaker) to the 120 volt power source running into the residence or building within which the system is installed. As a result, the light source and the motion sensor may be powered without the use of batteries, thereby increasing the life of such components and eliminating the need for periodic maintenance.

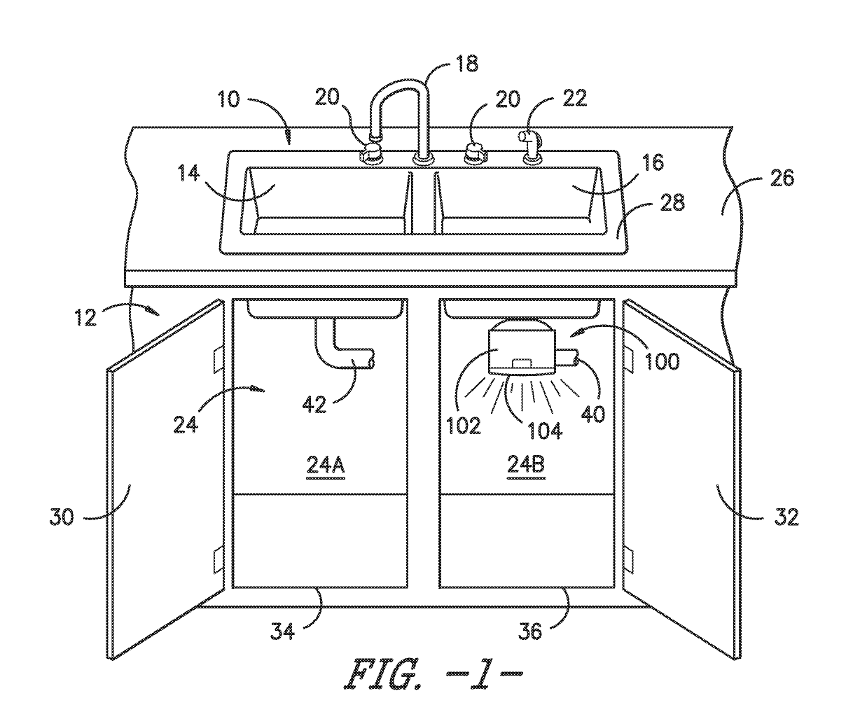

Referring now to the drawings, FIG. 1 illustrates a perspective view of one embodiment of a kitchen sink 10 and associated under-sink cabinetry 12 in accordance with aspects of the present subject matter. As shown, the sink 10 is configured as a dual-bowl sink. Thus, the sink 10 includes a left or first sink bowl 14 and a right or second sink bowl 16 positioned side-by-side. However, in other embodiments, the sink 10 may have any other suitable configuration, such as by being configured as a single-bowl sink. As shown in FIG. 1, a faucet 18, knobs 20 and/or any other suitable accessories (e.g., a sink sprayer 22) may be associated with the sink 10.

In several embodiments, the sink 10 may be supported vertically above an under-sink storage space 24 via a countertop 26 and the associated cabinetry 12. Specifically, the sink 10 may include an outer rim 28 extending around its periphery that is configured to be engaged against the countertop 26 such that the sink bowls 14, 16 are received within a corresponding sink opening (not shown) defined in the countertop 26. The countertop 26 may, in turn, be positioned atop the cabinetry 12 such that cabinet doors 30, 32 associated with the cabinetry 12 may be utilized to access the under-sink storage space 24. For example, as shown in FIG. 1, a left or first cabinet door 30 may be mounted within a first opening 34 of the cabinetry 12 for providing direct access to a left or first portion 24A of the under-sink storage space 24. Additionally, a right or second cabinet door 32 may be mounted within a second opening 36 of the cabinetry 12 for providing direct access to a right or second portion 24B of the under-sink storage space 24. In such embodiment, each cabinet door 30, 32 may be selectively opened and closed to access and close-off, respectively, the under-sink storage space 24. In other embodiments, the cabinetry 12 may have any other suitable number of cabinet doors for accessing the under-sink storage space 24, such as a single cabinet door or three or more cabinet doors.

Additionally, as shown in FIG. 1, a system 100 for lighting the under-sink storage space 24 may be installed within the under-sink cabinetry 12. Specifically, as will be described below, the system 100 may include a waste disposal 102 positioned within the under-sink storage space 24 and a light source 104 integrated within the disposal 102 or otherwise associated therewith. By associating the light source 104 with the disposal 102, an improved lighting solution may be provided for the under-sink storage space 24 (e.g., as opposed to mounting a light onto one of the cabinet doors 30, 32 or onto one of the walls or floor of the cabinetry 12).

As shown in the illustrated embodiment, the waste disposal 102 is mounted in fluid communication with the second sink bowl 16. As such, water and/or waste discharged from the second sink bowl 16 may be processed by the waste disposal 102 and subsequently discharged therefrom via a suitable discharge pipe 40. In such an embodiment, a standard drain pipe 42 may be mounted to the first sink bowl 14 for draining water (and, potentially, waste) from the first sink bowl 14. Alternatively, the waste disposal 102 may be mounted in fluid communication with the first sink bowl 14, with the drain pipe 42 being mounted to the second sink bowl 16. As is generally understood, the discharge pipe 40 and the drain pipe 42 may be coupled to a common wastewater pipe (not shown) of the associated residential or building plumbing.

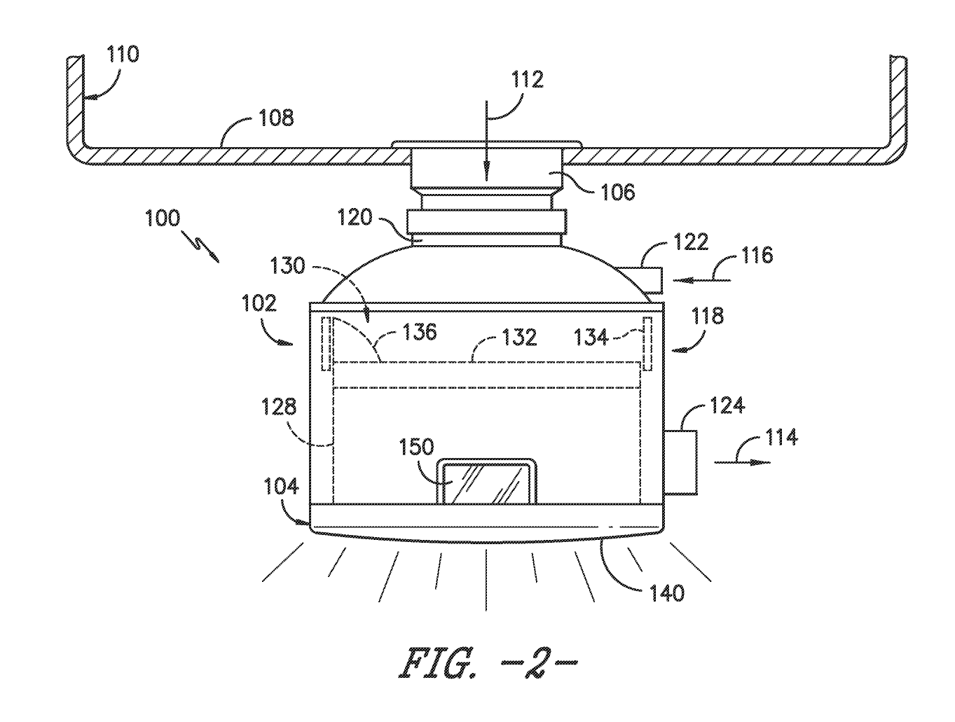

Referring now to FIG. 2, a side view of one embodiment of the system 100 described above is illustrated in accordance with aspects of the present subject matter. As shown, the system 100 may generally include a waste disposal 102 and a light source 104 associated therewith. In general the waste disposal 102 may be configured to be mounted to a sink drain 106 extending from the bottom of a sink bowl 108 of a corresponding sink 110 (e.g., the second sink bowl 16 of the sink 10 shown in FIG. 1). As is generally understood, while the sink 110 is being used, water and waste (e.g., food waste and other solid waste) may collect within the sink bowl 108 and may be subsequently discharged therefrom via the drain 106. The water and waste flowing through the drain 106 may then be directed into the waste disposal 102 (as indicated by arrow 112), wherein the waste may be processed into fine particulates. The water and processed waste may then be discharged from the waste disposal 102 (as indicated by arrow 114) into a suitable flow conduit or discharge line of the associated plumbing (e.g., discharge pipe 40 shown in FIG. 1). Additionally, as shown in FIG. 2, in several embodiments, the waste disposal 102 may also be configured to receive water and/or waste discharged from a dishwasher (not shown) in fluid communication with the disposal 102 (as indicated by arrow 116). In such embodiments, the waste received from the dishwasher may similarly be processed into fine particulates and subsequently discharged from the waste disposal 102.

In general, the waste disposal 102 may include a housing 118 configured to form an outer casing or enclosure for the various other components of the disposal 102. In general, the housing 118 may have any suitable configuration that allows it to function as a casing or enclosure for the disposal components. For instance, the housing 118 may be formed from two or more housing components configured to be coupled to one another so as to form a complete housing assembly, such as by forming the housing from a upper housing portion configured to be coupled to a lower housing portion.

In addition, the housing 118 may define one or more inlets and outlets for receiving and discharging water and/or waste. For instance, a primary inlet 120 may be defined in the housing 118 (e.g., at the top of the housing 118) for receiving water/waste discharged from the sink 110 and a secondary inlet 122 may be defined in the housing 118 for receiving water and/or waste discharged from a dishwasher in fluid communication with the disposal 102. In addition, a discharge outlet 124 may be defined in the housing 118 (e.g., at and/or adjacent to the bottom of the housing 118) for discharging water and processed waste from the disposal 102.

As shown in hidden lines in FIG. 2, the disposal 102 may also include a motor 128 and a cutter system 130 disposed within the housing 118. As is generally understood, the motor 128 may be configured to rotate a cutter plate 132 of the cutter system 130 directly below a grind chamber (not shown) defined within the housing 118 between the cutter plate 132 and the primary inlet 120. Thus, as the cutter plate 132 is rotated, water/waste entering the grind chamber via the primary inlet 120 may be directed radially outwardly along the plate 132 towards a stationary cutter ring 134 of the cutter system 130 disposed around the inner perimeter of the housing 118 (i.e., around the outer perimeter of the grind chamber). In addition, the cutter plate 132 may include a cutter lug 136 coupled thereto and/or extending therefrom for pushing waste flowing along the outer perimeter of the plate 132 into the adjacent cutter ring 134. The cutter ring 134 may, in turn, define a plurality of cutter slots (not shown) that serve to grind, shred, cut and/or otherwise process the waste. Accordingly, the waste flowing along the outer perimeter of the cutter plate 132 may be pushed by the cutter lug 136 into and/or against the cutter slots of the stationary cutter ring 134 in order to process the waste into fine particulates. The processed waste may then be discharged from the disposal 102 via the discharge outlet 124.

It should be appreciated that the motor 128 and the cutter plate 132 of the disclosed disposal 102 may generally have any suitable configuration known in the art that allows such components to function as described herein. For instance, in one embodiment, the motor 128 may have an outrunner or external rotor configuration. As such, the motor 128 may include a stator (not shown) and an external rotor (not shown) extending around the outer circumference of the stator. In such an embodiment, the cutter plate 132 may be formed integrally with the external rotor, such as by forming the cutter plate 132 as all or a portion of the top wall of the rotor, or the cutter plate 132 may be coupled to the rotor using any other suitable means, such as by using mechanical fasteners. In other embodiments, the motor 128 may have an internal rotor configuration and may include a shaft (not shown) extending outwardly therefrom. In such embodiments, the cuter plate 132 may be coupled to the motor shaft for rotation therewith.

It should also be appreciated that, in alternative embodiments, the system 100 may include a waste disposal 102 having any other suitable configuration known in the art that allows for the processing of water and/or waste flowing from a sink, dishwasher and/or any other source.

Referring still to FIG. 2, as indicated above, the system 100 may also include a light source 104 integrated within and/or otherwise associated with the waste disposal 102 for lighting at least a portion of the surrounding under-sink storage space 24 (FIG. 1). In several embodiments, the light source 104 may be configured to be integrated within a portion of the disposal housing 118, such as by forming a suitable recess, cavity or opening within the housing 118 for receiving the light source 104. Alternatively, the light source 104 may simply be attached to an outer surface of the housing 118. Regardless, it should be appreciated that the light source 104 may be configured to be coupled to the housing 118 using any suitable means and/or methodology, such as by using mechanical fasteners (e.g., bolts, screws, pins, brackets, clips, and/or the like), by using adhesives, by using a mechanical or friction fit (e.g., by pressing fitting or snapping the light source 104 into a suitable recess, cavity or opening defined in the housing 118) and/or by using any other suitable attachment means and/or methodology known in the art.

In several embodiments, the light source 104 may be disposed along the bottom side of the waste disposal 102. For instance, as shown in FIG. 2, the light source 104 may be coupled to or otherwise positioned adjacent to the bottom of the waste disposal 102 such that the light source 104 forms a bottom surface 140 of the entire assembly. As such, the light projected outwardly form the light source 104 may be directed towards the portion of the under-sink storage space 24 disposed thereunder. However, in other embodiments, the light source 104 may be positioned at any other suitable location on the waste disposal 102. For instance, in another embodiment, the light source 104 may be disposed at a location along the sidewall of the housing 118.

It should be appreciated that, although the illustrated embodiment shows a single light source 104, the disclosed system 100 may generally include any number of light sources integrated within and/or otherwise associated with the waste disposal 102. For instance, in a particular embodiment, the system 100 may include two or more light sources for lighting the under-sink storage space 24. In such an embodiment, the light sources may be positioned relative to the housing 118 in any manner so as to enhance the lighting capability of the disclosed system 100, such as by positioning one or more light sources along the bottom of the housing 118 and one or more light sources at a location(s) along the sidewall of the housing 118.

It should also be appreciated that the light source 104 may generally correspond to any suitable lighting device(s) and/or element(s) capable of producing visible light. For instance, in several embodiments, the light source 104 may correspond to one or more light emitting diodes (LEDs). LEDs typically provide long-life, high durability, high intensity and low energy consumption characteristics. As a result, an LED light source(s) may be particularly useful as a source for under-sink lighting. However, in other embodiments, the light source 104 may correspond to any other suitable lighting device(s) and/or element(s), such as one or more electroluminescent lamps, incandescent lamps, gas discharge lamps, high-intensity discharge lamps or any other known light source.

Additionally, in several embodiments, the system 100 may include a motion sensor 150 configured to turn on or otherwise activate the light source 104 upon the detection of motion. In general, the motion sensor 150 may be configured to be positioned at any suitable location that allows it to detect motion occurring within and/or adjacent to the under-sink storage space 24. For instance, as shown in FIG. 2, the motion sensor 150 may be integrated within and/or otherwise coupled to the housing 118, such as by being positioned at a location on the sidewall of the housing 118. In such an embodiment, the motion sensor 150 may, for example, be configured to be oriented in the direction of the cabinet door(s) 30, 32 of the associated under-sink cabinetry 12 to allow the motion of the cabinet doors 30, 32 to trigger the sensor 150. As such, upon opening the cabinet door(s) 30, 32, the sensor 150 may activate the light source 104, thereby providing lighting within the under-sink storage space 24. In addition to such door movement (or as an alternative thereto), the motion sensor 150 may be configured to sense any other suitable movement or motion occurring within and/or adjacent to the under-sink storage space 24. For example, in a particular embodiment, the motion sensor 150 may only be configured to detect motion occurring directly adjacent to the sensor 150, such as when a consumer swipes or otherwise moves his/her hand directly adjacent to the sensor 150.

It should be appreciated that the motion sensor 150 may generally correspond to any suitable motion sensing device(s) and/or element(s) known in the art. For instance, in one embodiment, the motion sensor 150 may be correspond to any suitable device(s) and/or element configured to sense movement based on the change in frequency of reflected sound waves or electromagnetic pulses (i.e., based on the Doppler effect), such as an ultrasonic or microwave motion sensor. Alternatively, the motion sensor 150 may correspond to any other suitable motion sensing device(s) and/or element(s), such as an active or passive infrared motion sensor.

In several embodiments, upon activation of the light source 104 via the motion sensor 150, the light source 104 may be configured to remain turned on for a predetermined period of time. Specifically, the light source 104 may remain activated for a given delay period (e.g., 10 seconds, 30 seconds, a minute or any other suitable time period) following the last motion detected by the motion sensor 150. Thus, for example, as a consumer is searching for an item(s) within the under-sink storage space 24 and the motion sensor 150 is actively sensing motion, the light source 104 may remain illuminated. However, once the consumer moves away from the under-sink storage space 24 (e.g., by closing the cabinet door(s)) and the motion sensor 150 is no longer sensing motion, the light source 104 may be maintained in its activated state for a short period of time prior to being turned off. By automatically shutting the light source 104 off after the predetermined time period, the system 100 prevents scenarios in which a consumer may inadvertently leave the light source 104 turned on after using the under-sink storage space 24, thereby resulting in reduced power usage and increased longevity of the light source 104.

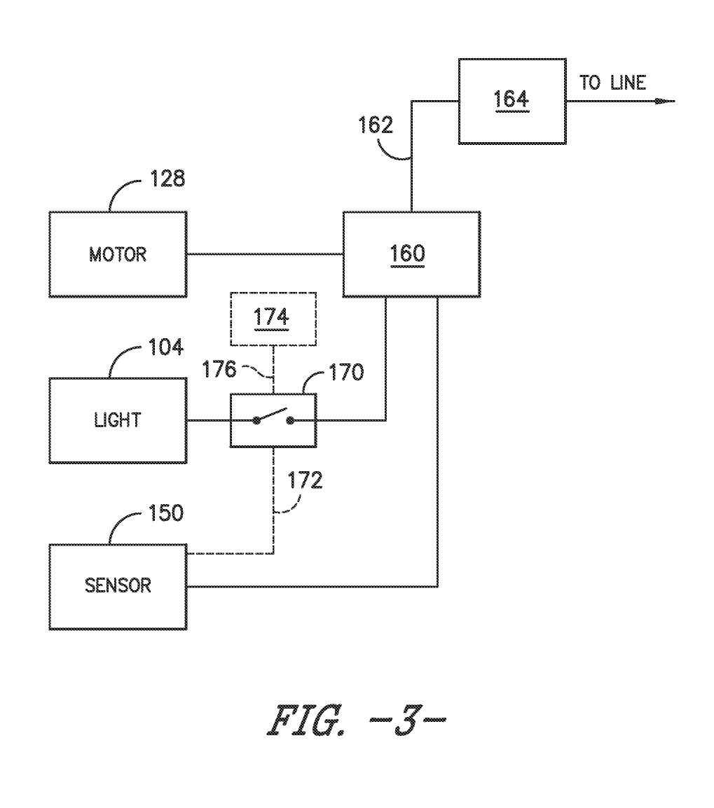

It should be appreciated that, in alternative embodiments, the light source 104 may be configured to be activated using any other suitable means and/or methodology. For instance, as will be described below with reference to FIG. 3, the system 100 may include a physical switch that may be used for switching the light source 104 on and off. In such an embodiment, the physical switch may, for example, be mounted or otherwise located at any suitable position on the disposal housing 118 that provides a consumer access thereto.

Referring now to FIG. 3, one embodiment of a simplified, schematic electrical diagram that can be utilized with the system 100 described above is illustrated in accordance with aspects of the present subject matter. In several embodiments, the disposal motor 128, the light source 104 and the motion sensor 150 may be configured to be coupled to a common electrical circuit such that each system component receives power from the same power source. For instance, as shown in FIG. 3, in one embodiment, the motor 128, the light source 104 and the motion sensor 150 may each be coupled to an internal electrical circuit 160 of the waste disposal 102. In such an embodiment, power transmitted from an external power source (e.g., the utility grid) may be directed through the internal circuit 160 to each system component. For example, as shown in FIG. 3, the internal circuit 160 may be coupled to an external electrical circuit 162 electrically connected between the system components and a circuit breaker or switch 164 of the residence or building within which the system 100 is installed. Of course, the circuit breaker 164 may, in turn, be electrically connected via suitable electrical lines to any suitable power source.

In other embodiments, the light source 104 and/or the motion sensor 150 may be coupled to the external power circuit 162 without being electrically connected to the internal circuit 160. In such embodiments, the common electrical circuit to which the disposal motor 128, the light source 104 and the motion sensor 150 are all coupled may correspond to the external circuit 162. Alternatively, if the light source 104 and/or the motion sensor 140 are coupled to a different external electrical circuit than the disposal 102, the common electrical circuit may correspond to the primary electrical circuit encompassing the various electrical sub-circuits (e.g., sub-circuit 162) contained within the residence or building within which the system 100 is installed.

It should be appreciated that, by powering the light source 104 and the motion sensor 150 via a wired connection to a grid-coupled power source, the need for battery power is eliminated. As a result, the disclosed system 100 may be installed and operated without requiring periodic maintenance (e.g., to replace the batteries).

Additionally, as shown in FIG. 3, an internal switching mechanism 170 may be associated with the light source 104 for cutting the supply of power thereto on and off, thereby allowing the light source 104 to be activated and deactivated via the switching mechanism 170. As indicated above, in several embodiments, the motion sensor 150 may be configured to activate the light sensor 104 based on detected motion. Thus, as shown in FIG. 3, the motion sensor 150 may be communicatively coupled to the switching mechanism 170 (e.g., via line 172). In such embodiments, the switching mechanism 170 may be normally in an open position such that the light source 104 is turned off. However, upon the detection of motion, the motion sensor 150 may be configured to transmit a suitable signal to the switching mechanism 170 in order to move the switch to the closed position, thereby activating the light source 104. Moreover, in embodiments in which the light source 104 is configured to remain activated for a predetermined period of time following the detection of motion, a timing mechanism or other suitable device (not shown) may be associated with the switching mechanism 170 to maintain the switch in the closed position for the prescribed delay period.

As indicated above, as an alternative to the motion sensor 150, the light source 104 may be configured to be activated instead using any other suitable means and/or methodology. For instance, as shown in FIG. 3, a physical switch 174 may be coupled to the switching mechanism 150 (e.g., via line 176) for switching the mechanism 150 between the opened and closed positions. In such an embodiment, the physical switch 174 may be mounted or otherwise located at any suitable location that allows the switch 174 to be manipulated by a consumer for turning the light source 104 on and off.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for lighting an under-sink storage space defined beneath a sink, the system comprising:
a waste disposal positioned within the under-sink storage space and being in fluid communication with the sink, the waste disposal including a motor and a cutter system for processing water and waste discharged from the sink; and
a light source associated with the waste disposal, the light source being configured to illuminate at least a portion of the under-sink storage space,
wherein the light source and the motor are electrically connected to a common electrical circuit.

2. The system of claim 1, wherein the common electrical circuit corresponds to an internal electrical circuit of the waste disposal.

3. The system of claim 1, wherein the light source is integrated within or coupled to a housing of the waste disposal.

4. The system of claim 1, further comprising a motion sensor associated with the waste disposal, the motion sensor being configured to activate the light source when movement is detected within or adjacent to the under-sink storage space.

5. The system of claim 4, wherein the motion sensor is electrically connected to the common electrical circuit.

6. The system of claim 4, wherein the motion sensor is integrated within or coupled to a housing of the waste disposal.

7. The system of claim 4, wherein the light source is configured to remain activated for a predetermined time period after movement is detected by the motion sensor.

8. The system of claim 1, wherein the light source comprises at least one light emitting diode.

9. The system of claim 1, wherein the common electrical circuit corresponds to an external electrical circuit electrically connected to an internal electrical circuit of the waste disposal.

10. The system of claim 1, wherein the light source is configured to be activated using a physical switch associated with the waste disposal.

11. A system for lighting an under-sink storage space defined beneath a sink, the lighting system comprising:
a waste disposal positioned within the under-sink storage space and being in fluid communication with the sink, the waste disposal including a motor and a cutter system for processing water and waste discharged from the sink;
a light source associated with the waste disposal, the light source being configured to illuminate at least a portion of the under-sink storage space; and
a motion sensor configured to activate the light source when movement is detected within or adjacent to the under-sink storage space.

12. The system of claim 10, wherein the motor and the light source are electrically connected to a common electrical circuit.

13. The system of claim 11, wherein the motion sensor is electrically connected to the common electrical circuit.

14. The system of claim 11, wherein the common electrical circuit corresponds to an internal electrical circuit of the waste disposal.

15. The system of claim 11, wherein the common electrical circuit corresponds to an external electrical circuit electrically connected to an internal electrical circuit of the waste disposal.

16. The system of claim 10, wherein the light source is integrated within or coupled to a housing of the waste disposal.

17. The system of claim 10, wherein the motion sensor is integrated within or coupled to a housing of the waste disposal.

18. The system of claim 10, wherein the light source is configured to remain activated for a predetermined time period after movement is detected by the motion sensor.

19. The system of claim 10, wherein the light source comprises at least one light emitting diode.

20. The system of claim 10, further comprising an internal switching mechanism associated with the light source, the motion sensor being configured to transmit a signal to activate the internal switching mechanism when motion is detected.
